(19) United States
(12) Patent Application Publication
(10) Pub. No.: US 2011/0035383 A1
(43) Pub. Date: Feb. 10, 2011

(54) Advanced Text to Speech Patent Search Engine

(76) Inventor: Shankar R. Ghimire, Fairfax, VA (US)

Correspondence Address: Shankar R. Ghimire, Apt 104, 3947 Persimmon DR., Fairfax, VA, 22031, US

(21) Appl. No.: 12/536,485

(22) Filed: Aug. 6, 2009

(51) Int. Cl. G06F 17/30; G10L 15/26

(52) U.S. Cl. 707/748; 704/235; 707/E17.014

(57) ABSTRACT

An efficient and stress relieving patent, and non-patent literature database search system has been provided. The system allows for the processing of dynamic and focused search strategies. The user can input a plurality of search features into the GUI of the system and can assign their priority. One of them can be classified as focused/high priority search feature over others. The system also allows for inputting plurality of keywords into the GUI to help ranking of the result. In a preferred embodiment, keywords, or portions or complete sentences or paragraphs can be listened by utilizing text to speech conversion technology. This allows users to go through a long list of patents/publications without requiring to read them. The user can listen the text to speech converted keywords or portions of references in a relaxing and way by utilizing a headset. This provides a fast and very efficient way of studying references with little or no stress. User can select various soothing sounds to be played briefly before switching into another reference. Various keyboard key operations are used to switch between the key features of the search and references.

### CROSS REFERENCE TO RELATED APPLICATIONS

This application claims priority under 35 USC 119(e) (1) of U.S. Provisional Patent Application Ser. No. 61/137,972 filed on Aug. 5, 2008.

### FIELD OF THE INVENTION

This invention relates generally to search engine for patent and non-patent literatures search.

### BACKGROUND OF THE INVENTION

Existing search engines provide several advanced search features. Users do not have to read through all references thoroughly. The highlighting of the features allows users to quickly go through the most important features of the search, and helps users to make decisions whether the particular reference discloses the features he is searching for. Various successful search engines are now in existence helping users to pursue technical research. Some of them are USPTO patent and publication search engine, PatBase, Delphion, and IEEE etc. All of them have advanced search features wherein a user can use proximity operators that allow the keywords to be searched within certain proximity, highlight them so that they can be quickly seen and read. USPTO EAST search system allows users to search his keywords within a sentence, paragraph, claims, abstract, title etc. USPTO East and PatBase allow for advanced highlighting of the keywords in different color as selected by the users. They have additional means to display portions of patent or publication containing keywords. A utilizing these systems a user can scan through his references quickly, jump into the region of high density of the keywords etc. USPTO EAST allows for fast retrieval and scanning through the images. PatBase and Delphion have thesaurus capability wherein user can supply one word to the search system and system will automatically include synonyms into search system. Google search system is one of the highly used search system for general and technical research. Its advanced search engine allows for the researchers to use phrases, and AND or OR operators.

These search engines have extraordinarily enhanced the searching of patents, publications and domestic and international references. However, during the search, the users generally have to go through several hundreds, sometimes even several thousand references. An infringement and state of the art searches may require even more number of references to go through. While going through so many references, researcher can be easily get stressed, or may loose the focus while flipping through several references. Constant reading of references having similar disclosures can become really uninteresting as well. This is a major problem that the current researchers are facing while searching by using the existing advanced and general search engines. None of the existing search engines have addressed this problem. There exists a need of an advanced search engine that can overcome this problem. In this invention, the inventor has proposed to overcome this problem by providing a text to speech converting advanced search engine that has a user friendly graphical user interface/input that allows researcher to focus on the key features of the search. This invention allows a searcher to listen a part or a complete sentence that has a keyword by utilizing a text to speech conversion technology and a head set. User will be able to listen keywords, sentences, sections or paragraphs of a reference that has keywords. User would be able to simultaneously listen and see the text or picture so that his search process will be substantially enhanced.

### SUMMARY AND DETAILED DESCRIPTION OF THE INVENTION

### Brief Description of the Drawings

FIG. 1 describes an embodiment of voice output user interface of the search engine)

FIG. 2 describes Keyword function for navigation of the references)

FIG. 3 describes various Process steps for using the Advanced Text to Speech Patent Search Engine)

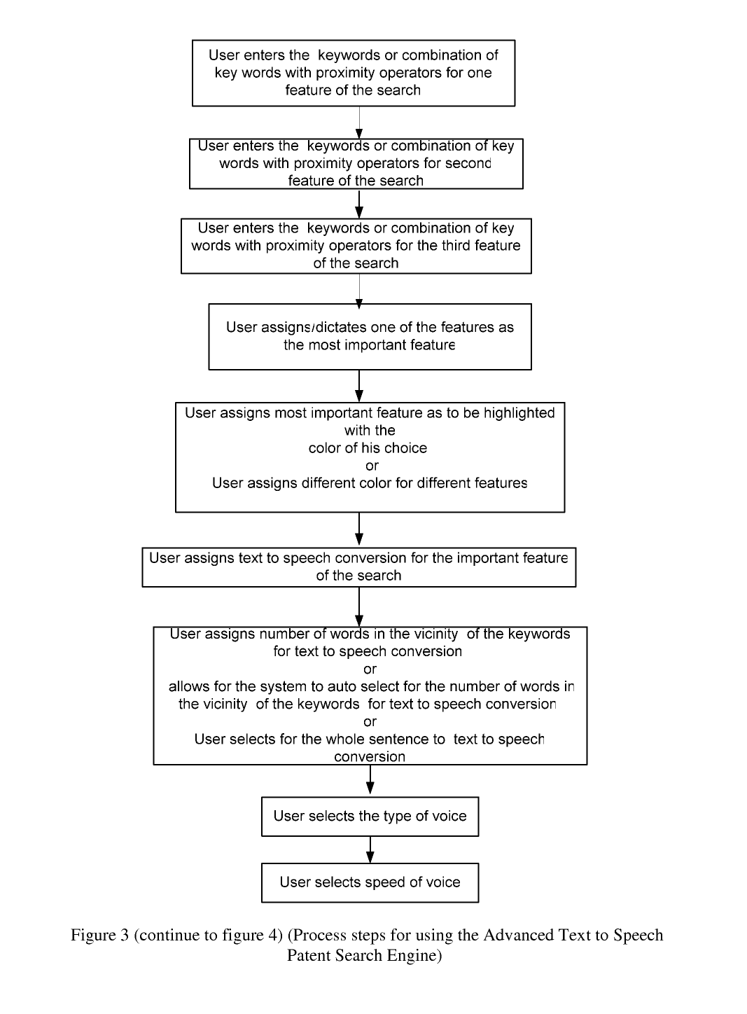

FIG. 4 is a continuation of FIG. 3

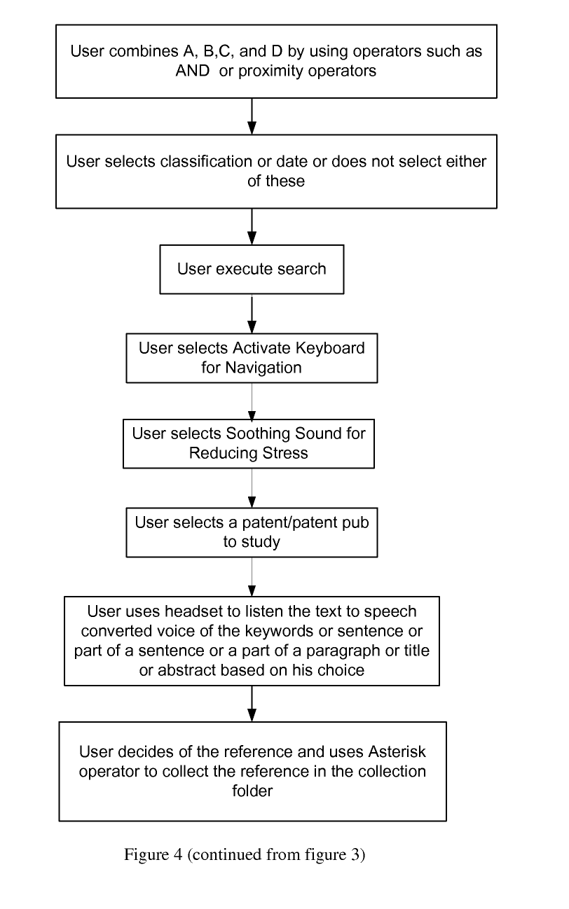

FIG. 5 describes a highly simplified version of Text to Speech Search Engine System

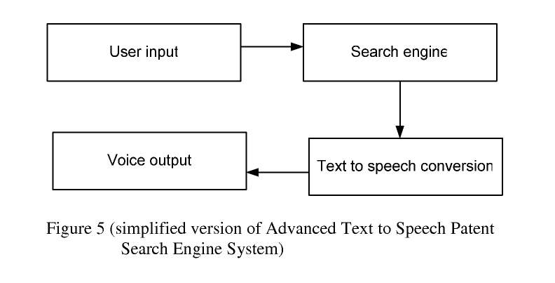

The objective of the invention is to provide a patent and/or non-patent literature search system wherein a searcher can input his search terms (keywords) with various operator and would be able to listen the selected part or portion of a sentence, or a complete sentence or paragraph or any portion of the reference containing the keywords by using text to voice/speech conversion technology/algorithm.

The invention includes plurality of graphical user interface (GUI) allowing users to input his keywords with various operators. A combination of keywords (search strings representing a feature or features of the search) with various operators (such as AND, OR, and proximity operators) is inputted in plurality GUI text box and priorities are assigned to these inputs. The user can specify different priorities to his inputs to different GUI text boxes. Similarly, the user can input various limitations of his choice, including but not limited to, classification, various dates (or date range as needed) such as filing date, application date, priority date, issue date, into the GUI. Most importantly, the user can assign various color schemes based on priority into the search system.

According to the preferred embodiment of the invention, a user can specify whether he wants to text to speech conversion to one or more keyword inputs (a search strings representing one more features of the search inputted in a GUI text box) to the GUI boxes. For example, the user can specify text to speech conversion to the priority 1 (high priority) GUI input box. After selecting the text to speech conversion, the user can select how many words in the vicinity of the keywords he wants the text to speech conversion and thus to listen after executing the search. The user also has options to select the text to speech conversion for a complete sentence, or select the auto select button wherein the system uses its determination technique to decide the length of the words for text to speech conversion. In another embodiment, the user can also select different speed of the speech for different priority inputs in the GUI box. In another embodiment, the user can select the type of voice for different priorities. In yet another embodiment, the user can have different highlight for each of different priority input in the GUI box.

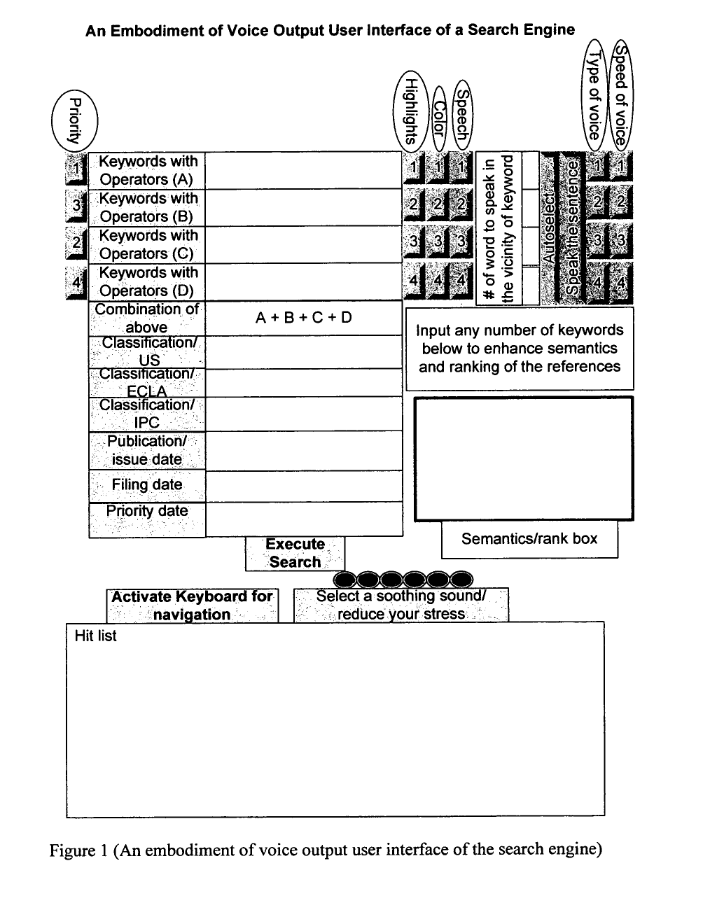

The system also allows for operation of various keyboard keys for navigation through different references. Once the search is executed the user can select the button “Activate Keyboard for Navigation” (see FIG. 1). This would activate the following keyboard operations for fast searching by text to speech conversion—
Shift: goes to the previous patent/patent pub; Up Arrow: Switches from one feature down to one feature up; Down Arrow: Switches from one feature up to one feature down; Home: reads title; Page up: reads abstract; Page down: reads claim; End: goes to the next patent/patent pub; Asterisk: copies the current patent/application and saves in a collection folder. Once copied, the corresponding patent/pub will be marked as copied.

In according to another preferred embodiment of the invention, user can select various a GUI buttons to select a soothing sound to be briefly played before switching into another reference/patent/publication (see FIG. 1).

In according to another preferred embodiment of the invention, the system utilizes semantic technologies to determine the length of the phrase that needs to text to speech converted to present to the users for listening and making decision of the reference.

In another preferred embodiment, system utilizes the keywords inputted in the semantics/rank box to decide the ranking of the references based on the number of keywords found in the reference that were inputted by the user in the symantics/rank box. The system utilizes semantic technology to decide the ranking of the references.

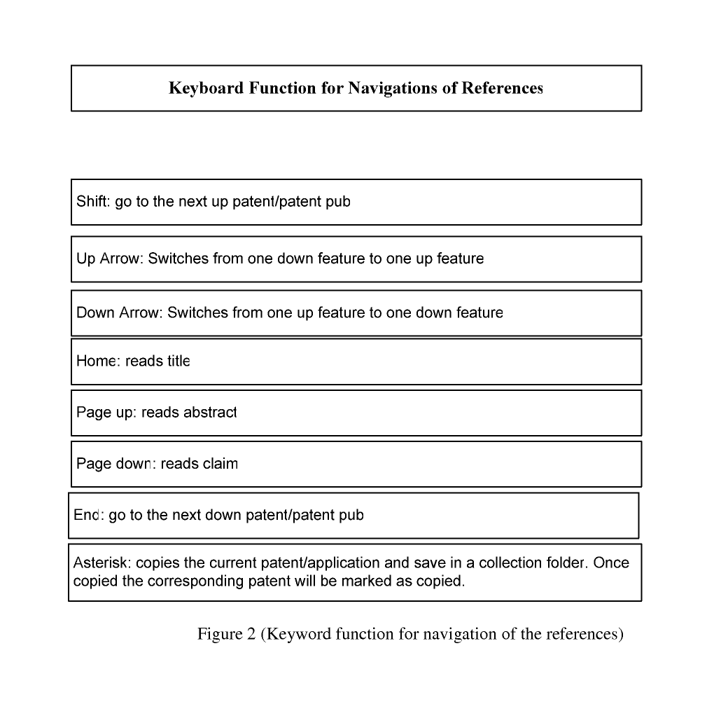

Once the user executes the search, a new page will be created with the list of references (patents/patent application publications). On the top is provided a user interface button that allows user to select whether to activate the keyboard operations. Once use selects “Activate Keyboard for Navigation”, the system will be ready to use keyboard for studying patents. As described in FIG. 2, the user can conduct a fast navigation by using this functionality. Additionally, a “Select a soothing sound/reduce your stress” button is provided to select various soothing sounds to be played in between the reference to help reduce the stress level. This is a user option. User may choose not to play any soothing sound as well.

The main objective of this invention is to provide an efficient and fast patent and patent application publication advanced search engine that allows searcher listen his search terms (keywords) or phrase of search terms by means of text to speech conversion technology and by utilizing a headset or any other equivalent device. User can listen a keyword, a part of a sentence, or a part of a paragraph, or title, or an abstract, or claim (s) etc by utilizing advanced text to speech conversion (TSC) patent search engine (TSC Patent Search Engine) of the invention. Any kind of text to speech conversion technology can be utilized in the search engine.

What is claimed is:

1. A patent and non-patent literature search system comprising:
a user friendly interface that allows a user to input a plurality of search terms/features (keywords or combination of keywords with operators) in a plurality of search input interfaces, wherein the user can assign priorities/ranks to the search terms/features before the execution of the search.

2. A patent and non-patent literature search system as set forth in claim 1, wherein the priorities to the search terms/features (keywords or combination of keywords with operators) can be assigned by the user by inputting a priority number in a priority input interface adjacent to the search input interface.

3. A patent and non-patent literature search system as set forth in claim 2, wherein
the user friendly interface includes selectively highlighting interfaces that allow a user to selectively highlight the search terms/features (keywords or combination of keywords with operators) by selecting one or more of the selectively highlighting interfaces.

4. A patent and non-patent literature search system as set forth in claim 3, wherein
the user friendly interface includes selectively coloring interfaces that allow a user to selectively highlight his search terms/features (keywords or combination of keywords with operators) by the color of his choice by selecting one or more of the selectively coloring interfaces.

5. A text to speech conversion patent and non-patent literature search system comprising:
a user friendly interface that allows a user to input a plurality of search terms/features (keywords or combination of keywords with operators) in a plurality of search input interfaces, wherein the user can assign priorities/ranks to the search terms/features before the execution of the search.
a text to speech conversion system, wherein the text to speech conversion system transforms the user keywords or combination of keywords or a portion of a sentence containing the keywords or a complete sentence(s) containing the keywords or an abstract or a title or a claim(s) or a paragraph(s) of the patent or a patent application or a literature into speech or voice.

6. A text to speech conversion patent and non-patent literature search system as set forth in claim 5, wherein the text to speech conversion system performs the text to speech conversion according to the user selection, wherein the user performs the selection by selecting one or more of the text to speech conversion interface.

7. A text to speech conversion patent and non-patent literature search system as set forth in claim 5, wherein the user friendly interface includes a user inputtable word vicinity interface, wherein after inputting a number in the word vicinity interface, the text to speech conversion is performed for a portion of a sentence in the vicinity of a keyword or combination of key words with operators, wherein the portion of the sentence is determined according to the user input of a number in the word vicinity interface.

8. A text to speech conversion patent and non-patent literature search system as set forth in claim 6, wherein the user friendly interface includes an autoselect interface that that will automatically determine the number of word in the vicinity of a keyword or a combination of keywords with operators to convert to the speech by performing a semantic analysis of the keyword and the words in the vicinity of the keywords.

9. A text to speech conversion patent and non-patent literature search system as set forth in claim 6, wherein the user friendly interfaces includes a speak sentence interface that allows to perform the text to speech conversion of a sentence that includes the keyword or combination of keywords when the speak sentence interface is selected.

10. A text to speech conversion patent and non-patent literature search system as set forth in claim 6, wherein the user friendly interfaces includes a voice selection interface that will allow a user to select the type of voice/speech in performing text to speech conversion.

11. A text to speech conversion patent and non-patent literature search system as set forth in claim 6, wherein the user friendly interfaces includes an speech speed interface that allows a user to select the speed of voice/speech after text to speech conversion.

12. A text to speech conversion patent and non-patent literature search system as set forth in claim 6, wherein the user friendly interfaces includes a semantic rank interface that allows a user to input a number of keywords to enhance the semantics and the ranking of the references located after the execution of the search.

13. A patent and non-patent literature search system as set forth in claim 1, wherein the user friendly interfaces includes a semantic rank interface that allows a user to input a number of keywords to enhance the semantics and the ranking of the references after the execution of the search.

14. A patent and non-patent literature search system comprising:
a user friendly interface that allows a user to input a plurality of search terms/features (keywords or combination of keywords with operators) in a plurality of search input interfaces, wherein the user can assign priorities/ranks to the search terms/features before the execution of the search,
wherein the priorities/ranks to the search terms/features (keywords or combination of keywords with operators) can be assigned by the user by inputting a priority number in a priority input interface adjacent to the search input interface,
wherein the user friendly interface includes selectively highlighting interfaces that allow a user to selectively highlight the search terms/features (keywords or combination of keywords with operators) by selecting one or more of the selectively highlighting interfaces,
wherein the user friendly interface includes selectively coloring interfaces that allow a user to selectively highlight his search terms/features (keywords or combination of keywords with operators) by the color of his choice by selecting one or more of the selectively coloring interfaces,
wherein the user friendly interfaces includes a semantic rank interface that allows a user to input a number of keywords to enhance the semantics and the ranking of the references.

15. A text to speech conversion patent and non-patent literature search system as set forth in claim 6, wherein the user friendly interfaces includes a soothing sound interface that allows a user to select a soothing sound between the navigation of the references.

16. A text to speech conversion patent and non-patent literature search system as set forth in claim 6, wherein the user friendly interfaces includes a keyboard activation interface that activates the keyboard commands for the navigation of the references after executing the search.

17. A text to speech conversion patent and non-patent literature search system as set forth in claim 18, wherein the keyboard commands for the navigation of the references include
Shift for going to the previous patent/patent pub,
Up Arrow for switching from one feature down to one feature up,
Down Arrow for Switching from one feature up to one feature down,
Home for reading title,
Page up for reading abstract,
Page down for reading claims,
End for going to the next patent/patent pub, and
Asterisk for copying the current patent/application and saving in a collection folder.

18. A text to speech conversion patent and non-patent literature search system as set forth in claim 6, wherein the priority numbers and semantic keywords are used to rank the list of references after the execution of the search.
